(19) United States
(12) Patent Application Publication
(10) Pub. No.: US 2008/0195954 A1
(43) Pub. Date: Aug. 14, 2008

(54) DELIVERY OF CONTEXTUALLY RELEVANT WEB DATA

(75) Inventors: Baskaran Dharmarajan, Palo Alto, CA (US); Dennis Takchi Cheung, Sunnyvale, CA (US); Eliot Spencer Savarese, Pacifica, CA (US); Mukund Narasimhan, Bellevue, WA (US); Imran Khan, San Jose, CA (US); Denise K. Ho, Los Altos, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/673,125

(22) Filed: Feb. 9, 2007

(51) Int. Cl. G06F 3/00

(52) U.S. Cl. 715/749; 715/762

(57) ABSTRACT

A web-browser plug-in is described herein that detects the type of content a user selects on a web page and allows the user to retrieve additional information about selected web content or initiate a communication application. The plug-in analyzes the user's selection to determine what type of web content was selected. A smart menu is created and presented to the user with options relating to the type of web content selected. The user can then either download additional information about the web content or initiate a communication application without having to navigate to another web page or request information from a web service. Without having to navigate to a second web page, the user can select an option and either view the additional web information or initiate the communication application.

### BACKGROUND

The Internet is a worldwide system of interconnected computer networks that transmit a wealth of content and information. The World Wide Web (the Web) is an information space accessible via the Internet in which online documents called web pages are stored and published for the entire world to access. Web users can view web pages that contain information about virtually any subject, organization, government entity, or individual. Users can access web pages via the Internet by requesting uniform resource locators (URLs)—otherwise known as web addresses—in a web browser. In actuality, the URLs merely provide pointers to internet protocol (IP) addresses where web page content can be retrieved.

Web pages can contain a myriad of content—such as, hyperlinks, pictures, video, street addresses, telephone numbers, stock quotes, and city names. Unlike hyperlinks which allow a web-page viewer to request another web page with one mouse click, additional information about other web content cannot be easily ascertained. For instance, a web blog discussing a specific stock may only list the stock's symbol. Web surfers viewing the blog may wish to check its current price, requiring the surfers to access another web page (e.g., www.nyse.com, www.etrade.com, etc.), manually enter the stock symbol into a text field, and then click a SUBMIT button. This requires the user to: (1) navigate to a second web page that provides the functionality of checking stock prices, (2) copy or remember the stock symbol, (3) paste or type the symbol into a text field on the second web page, and (4) click a submit button. These four steps require time and effort along with knowledge of a second web page where such information can be found.

The same requirements are needed to access additional web information about various other web content. For example, it may be desirous to obtain a map of a street address or view the weather forecast for a given city. Unless the web-page developer has added such content to the web page, a user would have to seek out an additional web page to locate such information. As a result, the surfer's experience is limited to the content provided by the developer.

Many web pages list e-mail addresses, phone numbers, and other contact information. Developers can add hyptertext markup language (HTML) tags to such information to provide enable users to call or e-mail with a push of a button. If the developer does not add such code, a telephone number or e-mail address on the web page will be listed as alphanumeric text—without any functionality. Users must then paste or manually type the telephone number into a phone-service application or e-mail address into an e-mail messenger. Such efforts also take time, effort, and computer proficiency.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments are directed to a web-browser plug-in that detects the type of content a user selects on a web page. The content may me be a street address, geographic location, stock symbol, company name, telephone number, or e-mail address. A parser in the plug-in determines the type of web content selected. Additional web information about the selected content is located based on the type of web content the user selected. Options are presented in a smart menu to the user for retrieving additional web information. Depending on the type of web content, options to initiate a communication application relevant to the web content may also be presented to the user. Once the user selects an option, either the additional web information is presented or the communication application is initiated, without requiring the user to navigate to a second web page. In addition, a server is configured to update the plug-in with additions or modifications files.

Embodiments also refer to a server-client model for distributing a plug-in that performs the above operations. The server transmits a pointer file that identifies the location of files for the plug-in to the client. The client uses the pointer file to determine a cryptographic hash value that can be used to secure transmission of the files. The files validated by multiple hash values stored in trusted, signed files. If the client can verify the files, they can be downloaded.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary operating environment for use in implementing an embodiment of the present invention;

FIG. 2 is a block diagram of a networking environment for use in implementing an embodiment of the present invention;

FIG. 3 is a flowchart illustrating a process for transferring data associated with a web-browser plug-in to a client computing device, according to an embodiment of the present invention;

FIG. 4 is a flowchart illustrating a process for a user to retrieve additional web information or initiate a communication application, according to an embodiment of the present invention;

FIG. 5A is an exemplary display of a graphical user interface for presenting an option to retrieve additional web information based on user-selected web content, according to an embodiment of the present invention;

FIG. 5B is an exemplary display of a graphical user interface for presenting retrieved additional web information about user-selected web content, according to an embodiment of the present invention;

FIG. 5C is an exemplary display of a graphical user interface for presenting an option to initiate a communication application, according to an embodiment of the present invention; and

FIG. 5D is an exemplary display of a graphical user interface for presenting an indication of a communication application, according to an embodiment of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

In general, embodiments described herein generally relate to a web-browser plug-in for detecting when a user selects web content on a displayed web page, determining what type of web content the user selected, and allowing the user to retrieve additional web information about the selected content. Additionally, some embodiments are directed to providing a user with the ability to initiate a communication session over the Internet using the selected web content—for example, when the web content is a phone number, e-mail address, IP address, or the like.

In one embodiment, a user can select any content on a web page, and, based on the user's selection, a smart menu containing user options will be presented to the user. A smart menu refers to a menu with user options that change based on the web content selected by the user, instead of a “dumb” menu which would only display the same options every time. User options refer to different actions the user may wish to perform with the user-selected web content. Examples of additional web information may include, without limitation, the weather in a geographic location, a map of a street address, driving directions to or from a street address, a price of a stock, a photographic image of a person, a video of an incident, or any other online information that may relate to the selected web content. In one embodiment, the additional web information is located on another web page; however, in other embodiments, a web service executing on a server is queried to obtain the additional web information. For example, Extensible Markup Language (XML) messages may be communicated across a computer network using a Simple Object Access Protocol (SOAP) or similar protocol. Embodiments are not limited to accessing web pages or web services; rather, any method of communicating web information well known to those skilled in the art may alternatively be used.

A user can select web content by double-clicking a mouse cursor on information on a web page. The user may also select the web content by ragging the cursor across the content, highlighting the web content, moving a cursor with a track ball, or any other well-known method of selecting web information on the web.

Depending on the user-selected content, smart menus may also include options for initiating application, that enables multiple users to communicate with one another. Such an application is referred to herein as a communication application and may include various technologies. Examples of communication applications include, without limitation, electronic mail (e-mail) applications (e.g, Microsoft Outlook®, MSN Hotmail®, etc.) and instant messaging applications (e.g., MSN® Messenger®, Google Talk, etc.). In addition, communication applications may also refer to telephonic services provided over a broadband network using a voice over Internet protocol (VOIP), peer to peer VOIP, wireless service, landline, or the like. Moreover, communication applications may also encompass videotelephonic (VTC) services broadcast over a computer modem. Such telecommunication technologies are generally well known.

Web content, as described herein, refers to any alphanumeric text, image, object, animation, sound, or other portion of a web page. Types of web content, as described herein, refer to different classifications of information found on the web. Examples include, without limitation, e-mail addresses, phone numbers, stock symbols, street addresses, weather forecasts, geographic locations, URLs, etc. For example, xyz@abc.com on a web page would be considered web content, while its type is an e-mail address. In another example, a succession of numbers and letters followed by an abbreviation of the word “street” would be considered a street address. In yet another example, four successive capital letters may be classified as a stock symbol. Embodiments are not limited, however, to any particular web content or type of web content discussed herein. One skilled in the art will understand that virtually anything presented on a web page may be considered web content—including images and video—and the classifications of web content types are only limited by the imagination. Embodiments are not limited to any particular web content. Rather, one skilled in the art will understand that some embodiments described herein contemplate a plethora of digital data.

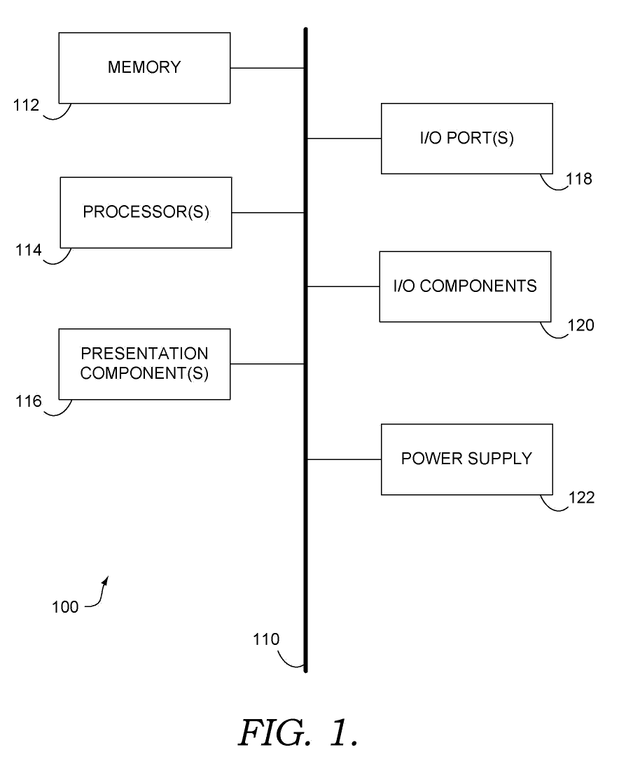

Having described a general overview of the embodiments described herein, an exemplary operating environment is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

The invention may be described in the general context of computer code or machine-useable instructions, including computer-executable instructions such as program modules, being executed by a computer or other machine, such as a PDA or other handheld device. Generally, program modules including routines, programs, objects, components, data structures, and the like, refer to code that perform particular tasks or implement particular abstract data types. Each module described herein may represent executable source code written in a well-known language, such as, for example, C, C++, C#, Java, or the like. Embodiments described herein may be practiced in a variety of system configurations, including hand-held devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

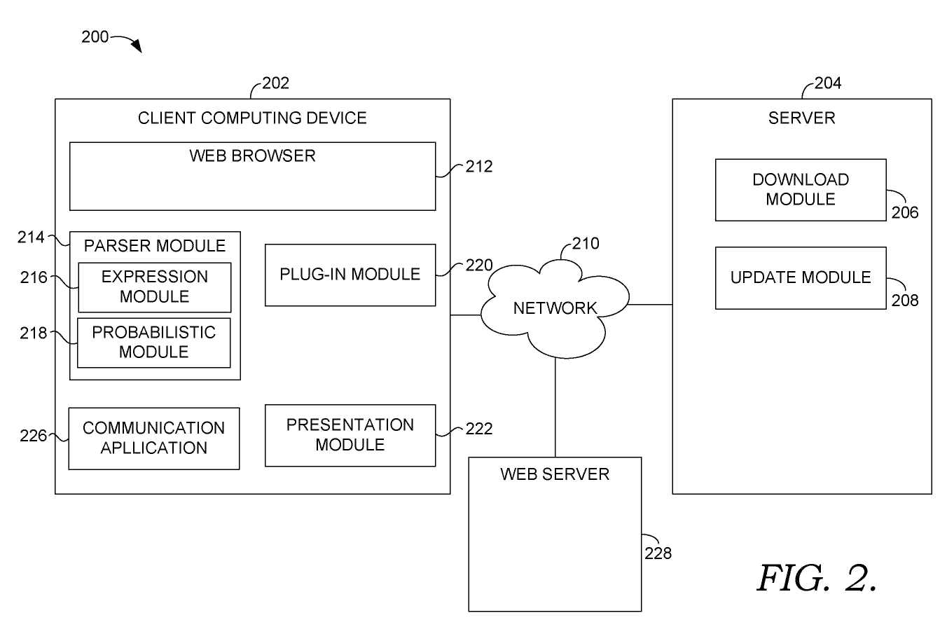

Turning now to FIG. 2, a block diagram depicting a networking architecture 200 is shown for use in implementing an embodiment of the present invention. The networking architecture 200 comprises a client computing device 202, a server 204, and a web server 228, all of which communicate with each other via network 210. Networking architecture 200 is merely an example of one suitable networking environment and is not intended to suggest any limitation as to the scope of use or functionality of the present invention. Neither should networking architecture 200 be interpreted as having any dependency or requirement related to any single component or combination of components illustrated therein.

The client computing device 202 may be any type of computing device, such as device 100 described above with reference to FIG. 1. By way of example only and not limitation, the client computing device 202 may be a personal computer, desktop computer, laptop computer, handheld device, cellular phone, digital phone, smartphone, PDA, or the like. It should be noted that embodiments are not limited to implementation on such computing devices.

Network 210 may include any computer network or combination thereof. Examples of computer networks configurable to operate as network 210 include, without limitation, a wireless network, landline, cable line, digital subscriber line (DSL), fiber-optic line, local area network (LAN), wide area network (WAN), metropolitan area network (MAN), or the like. Network 210 is not limited, however, to connections coupling separate computer units. Rather, network 210 may also comprise subsystems that transfer data between servers or computing devices. For example, network 210 may also include a point-to-point connection, the Internet, an Ethernet, an electrical bus, a neural network, or other internal system.

In an embodiment where network 210 comprises a LAN networking environment, components are connected to the LAN through a network interface or adapter. In an embodiment where network 210 comprises a WAN networking environment, components use a modem, or other means for establishing communications over the WAN, to communicate. In embodiments where network 210 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The server 204 and the web server 228 may be any type of application server, database server, or file server configurable to perform the methods described herein. In addition, each of the server 204 and the web server 228 may be a dedicated or shared server. One example, without limitation, of a server that is configurable to operate as the server 228 is a PowerEdge server manufactured by Dell, Inc. The server 228 may also be configured to run server software, such SQL Server 2005, which was developed by the Microsoft® Corporation, or Apache HTTP Server Project, developed by the Apache Software Foundation.

Components of the web server 228 may include, without limitation, a processing unit, internal system memory, and a suitable system bus for coupling various system components, including one or more databases for storing information (e.g., files and metadata associated therewith). The web server 228 may also include, or be given access to, a variety of computer-readable media. By way of example, and not limitation, computer-readable media may include computer-storage media and communication media. In general, communication media enables each server to exchange data via network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that networking architecture 200 is merely exemplary. While the servers 204 and 228 are illustrated as single boxes, one skilled in the art will appreciate that they are scalable. For example, the server 204 may in actuality include 100 servers in communication. The single unit depictions are meant for clarity, not to limit the scope of embodiments in any form.

The client computing device 202 comprises a web browser 212, parser module 214, plug-in module 220, presentation module 222, and communication application 226. Each module may comprise executable source code that can be downloaded to the client computing device 202 and stored in any of the aforementioned computer-storage media. For example, the parser module 214 may be cached to enable quick access.

The web browser 212 is a software application enabling a user to display and interact with information located on a web page. In an embodiment, the web browser 212 communicates with the server 204, the web server 228, and other components accessible over the network 210. Web pages may be located by the web browser 212 by sending a transferring protocol and the URL. The web browser 212 may use various URL types and protocols, such as file transfer protocol (FTP), real-time streaming protocol (RTSP), etc. The web browser 212 also understands a number of file formats—such as HTML, graphics interchange format (GIF), tagged image file format (TIFF), portable document format (PDF), or joint photographic experts group (PDF) file format, and the like—the wealth of which can be extended by downloaded plug-ins. Additionally, the web browser 212 may be any browser capable of navigating the Web, such as Internet Explorer®, Netscape Navigator, Mozilla, Firefox, etc.

The plug-in module 220 receives files for a plug-in for the web browser 212 from the server 204 over the network 210. In one embodiment, the plug-in files are received after the client-computing device 202 has made a request. In other embodiment, the plug-in files broadcast from the server 204. Embodiments are not limited thereto, however, as various other push, pull, or push-pull methods are also possible for transmitting the plug-in files to the client computing device 202.

The initial plug-in downloaded to the client computing device 202 comprises various files. In one embodiment, these files include the options that can be performed on various types of web content, a list of buttons that can be presented on the client computing device 202 as options, icons of the buttons, preview code for displaying smart menus, and the parser module 214. The options comprise software rules dictating when to display which options. For example, the option to retrieve a map when a street address is detected, or an option to retrieve a stock price only when stock symbols are detected. These options are implemented using if-then routines or logic. Alternatively, interrupts may be programmed to recognize when to display appropriate options. Other software configurations are also possible, and embodiments should not be limited to the aforementioned software implementations.

While options are discussed herein as being additions to a smart menu, embodiments are not limited thereto. Rather, the plug-in may be configured to automatically retrieve additional web information depending on the user-selected web content. For example, the plug-in may be configured to retrieve the current weather whenever a city is selected by the user, without first presenting a menu option to the user. Or, in another example, stock prices may be immediately retrieved whenever stock symbols are selected. To retrieve the additional web information automatically, client computing device 202 may be configured to launch multiple instances of the web browser 212 on background threads.

The multiple instances of the web browser 212 may be launched is a safe mode (commonly referred to as “restricted zone” in Microsoft's® Internet Explorer) to ensure retrieved information is not malicious. Safe mode means that no active components (such as scripts, APIs, controls, etc.) are executed when the web page is retrieved. Examples of active controls include, without limitation, JavaScript, ActionScript, ActiveX® controls, Flash applications, and the like. Retrieving the web pages in safe mode effectively protects the client computing device 202 from a host of malicious active components. One method of retrieving web pages in safe mode involves transmitting a header indicating a pre-fetching operation to the web server. It will be understood to those skilled in the art that various other methods are also possible and need not be discussed at length herein.

Options may be represented in a smart menu in text or as icons. Phrases describing the options or icons denoting options may be used. In one embodiment, these phrases and icons are cached for quick retrieval.

Preview code for displaying the smart menus includes machine instructions for showing an instant preview of additional information related to user-selected web content in a graphical user interface (GUI) window. For example, if the user selected a street address, a geographic map of the street address may be displayed in the foreground of a web browser. The preview code may also include code enabling a communication application GUI. For instance, an interactive window depicting a phone may be displayed when a phone application is calling a user-selected phone number. Or, in another example, an e-mail messenger (e.g., Microsoft Outlook®) can be positioned in the foreground of an active web browser, and a user-specified e-mail address may be automatically added as a recipient to an e-mail message. Other preview styles and menus may alternatively be downloaded and are generally well-known to those skilled in the art.

The parser module 214 determines what type of web content was selected by the user. For example, the parser module 214 is configured to ascertain whether the user selected a city, stock symbol, e-mail address, phone number, street address, or other type of content. To do so, the parser module 214 uses an expression module 216 and a probabilistic module 218, both of which are downloaded from the server 204.

The expression module 216 uses scripting programming language to detect whether selected web content contains an identifiable syntax. Examples of scripting programming languages that may be used to implement the expression module 216 include, without limitation, JavaScript, VBScript, Perl, and the like. In operation, the expression module 216 is configured to identify the type of web content selected by a user. For example, the expression module 216 may be configured to locate stock symbols by counting the number of capital letters in sequence in selected web content. Four sequential capital letters could designate a user's selection as a stock symbol. Similarly, the expression module 216 may determine that the user's selection is a telephone number by counting sequential numerals. If the selection includes ten numbers in a row, the user's selected content may be classified as a phone number. Additionally, the expression can be configured to monitor selected content for an @ symbol, to determine if an e-mail was selected. Those skilled in the art will understand that various other monitoring software can also be used to identify the type of web content selected by the user.

More ambiguous web content (i.e., web content without identifiable syntax) is detected by the probabilistic module 218. In operation, the probabilistic module 218 uses a heuristic, extraction model to determine the type of web content selected by a user. In one embodiment, the probabilistic module 218 executes an algorithm to parse web content. The input to the algorithm may be a piece of text, or some other document representation (e.g., HTML code), of the selected web content. The algorithm may be configured to output a sequence of token labels. For example, when the algorithm receives “123 Elm Street, #100, Seattle, Wash., 98004, (555)555-5555,” the following token sequence may be produced.

```
<Entity>
    <StreetAddress>123 Elm Street, #100<StreetAddress>
    <City>Seattle<City>
    <State>WA<State>
    <PostalCode>98004<PostalCode>
    <PhoneNumber>(555)555-5555<PhoneNumber>
```

To produce a sequence of tokens relevant to selected web content, the probabilistic module 218 utilizes an abstractor to identify various entities (e.g., State and PostalCode) as well as components of the entities (e.g., WA and 98004). The algorithm of the probabilistic module 218 is statistical, meaning it compares the probabilities that the components of entities are particular types. For example, the above component “Seattle” could be classified as a “City” because Seattle is: (1) listed on a list of city names, (2) begins with a capital letter, and (3) precedes text that is on a list of state names. These probabilistic rules may be given various values when weighed by the algorithm. For example, the fact that “Seattle” is on a list of city names could be assigned a 90% certainty that Seattle is a city; whereas, the fact that “Seattle” begins with a capital letter could only be assigned a 10% probability of being a city.

In one embodiment, the probabilistic module 218 uses a set of simple (although not conclusive) rules. Examples include, without limitation, a list of cities, a list of first names, a list of last names, a list of state names, capitalization-based features, length-based features, and other similar rules. Additionally, rules may also include regular expressions that match text patterns, such as, for example, capitalized words, all-digit text, all-capitalized text, or similar rules. In other embodiments, training data may be introduced to the probabilistic module 218, which may change various data over time.

In one embodiment, no particular rule is conclusive of the type of web content selected. Certainly many capitalized words are not city names; just because New York is on a list of city names does not make it a city (e.g., when followed by the word “Times” as used to designate the newspaper). In such an embodiment, the probabilistic module 218 combines the probabilities of many rules so that a decision about selected web content can be made with greater certainty. The probabilistic module 218 may be configured to learn to combine multiple sources of ambiguous information to determine what type of web content was selected by the user. Referring back to the above example, the probabilistic module 218 may consider that “Seattle” is on a list of city names as well as the fact that it is capitalized and precedes text that is on a list of state names. One skilled in the art will appreciate that numerous other rule combinations and probability combinations also exist.

In one embodiment, the probabilistic module 218 determines the type of web page selected by a user by first computing the probability that the selected web content fits within particular rules. Also, the probabilistic module 218 determines whether the preceding or following text indicates what type of content was selected. Next, the probabilistic module 218 searches for a set of rules that are mutually consistent (e.g., (1) it is uncommon to have two first names and (2) first names appear near last names). If consistent rules are found, in one embodiment, the web content is assigned a corresponding type. Or, alternatively, a combination of probabilities produced by rules may be used to assign a type. For example, selected content that is also on a list of cities, has a capitalized first letter, and precedes text on a list of states may represent 90%, 10%, and 80% probabilities, respectively, that the selected web content is a city. The probabilistic module 218 may be configured to then assign an overall probability of 30% (if weighted equally) or 80% (if the first rule is given more deference) that the selected web content is a city. A form of the probability percentage may be stored on either the client computing device 202 or the server 204 and used to determine the type of web content selected.

In addition, the parser module 214 may also use other well-known methods to recognize selected web content. For example, a Bloom filter (not shown for clarity) can be used to determine whether selected web content belongs to a list of data, without requiring that the client computing device 202 access a lookup table. Alternatively, a Markov chain or Bayesian model may be implemented in machine-readable code as well. Those skilled in the art will understand that various other statistical models may also be implemented and need not be discussed at length herein.

In one embodiment, the plug-in module 220 is configured to receive files associated with the plug-in as well as updates to those files. The plug-in module 220 receives the files described herein via a transfer protocol, such as HTTP, FTP, etc. Once received, the plug-in module 220 stores the files in cache. In one embodiment, the plug-in module is configured to periodically poll the server for updates to the plug-in. Alternatively, the server 204 may be configured to broadcast updates to the plug-in module 220.

The presentation module 222 is a combination of the web browser 212's existing display software and the plug-in. Downloaded icons, menus, and options of the plug-in are used by the presentation module 222 to display smart menus with the web browser 212's presentation scripts and control logic. Also, the presentation module 222 communicates with the parser module 214 to determine the type of web content selected by the user. Based on the type, the presentation module 222 selects which options to add to a smart menu. For each option, the presentation module 222 determines whether text or an icon should be presented to the user. The presentation module 222 also displays the smart menu as an overlay, in one embodiment, on top of an open web browser window. Other display options may also be incorporated into various embodiments. The presentation module 222 may be configured to display a smart menu with options in a foreground or background windows of the web browser 212 or in various tabs within a window of the web browser 212.

Once a smart menu is displayed, in one embodiment, the user may indicate an option whether to retrieve additional web information about selected web content or initiate the communication application 226 with the web content. If the former is selected, the presentation module retrieves the additional information from either a web service or web page hosted on the web server 228 via the network 210. In response, the web service or page returns HTML data corresponding to the data request. For example, if the user wishes to retrieve a stock quote, a request for the quote is sent to the web server 228, which returns the requested page or data to the client computing device 202. Or, in another example, the weather forecast for a city may be requested from a weather service hosted on the web server 228. The returned web information may be stored in cache on the client computing device 202 and then inserted into a viewing display. In one embodiment, the viewing display is larger than the smart menu. In another embodiment, the viewing display is presented in the foreground of the web browser and ideally positioned next to the user-selected web content. As previously mentioned, however, embodiments are not limited to user-initiated requests for web information. Rather, the plug-in may be configured to automatically retrieve the web information once the parser module 214 determines the type of web content selected by the user.

The presentation module 222 may also be configured to initiate the communication application 226 with the user-specified web content. In one embodiment, the communication application 226 is supplied with the user-specified web content. For example, a window for an e-mail messenger may be opened and populated with a selected e-mail address. In another example, the phone number selected by the user can used by a phone application to make a PC to PC call. Embodiments are not limited, however, to any of the aforementioned communication applications. One skilled in the art will understand that numerous applications are available and may also be used.

The communication application 226 allows users to communicate with each other. It comprises applications already on the client computing device 202 that may communicate with various servers, gateways, and telecommunication. Instant messaging services, e-mail messengers, telephone service, VTC, and other Internet-based telecommunications may use as the communication application 226. While the communication application 226 is illustrated in the client computing device 202 of FIG. 2, one skilled in the art will understand that various independent components not depicted in FIG. 2 may also be used to support communication. For instance, an Internet phone service may require a fiber-optic network or peer-to-peer network along with VOIP capabilities. One example of such a service would be the Verizon Web Calling Service used by Microsoft® Windows Live™ Call.

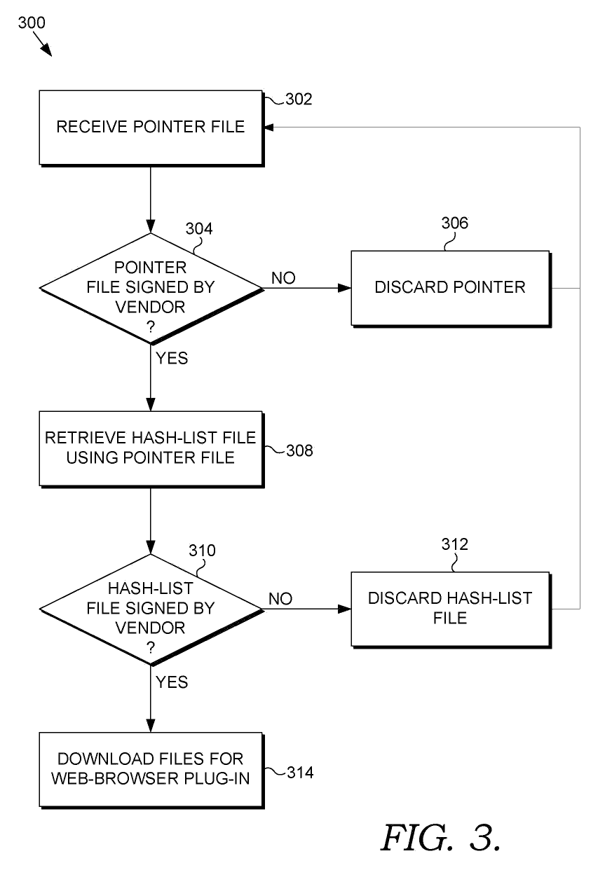

In one embodiment, the server 204 hosts a web service that allows client computing devices to download a web-browser plug-in. Users can access the web service by visiting a specific URL, which provides access to a web page where the plug-in can be downloaded. The plug-in enables a web browser executing on the client computing device 202 to generate and display smart menus as described herein. The plug-in is downloaded securely, as discussed in further detail below with reference to FIG. 3. In one embodiment, a user can register to download the plug-in from a web page hosted on the server 204, and download can only occur after a username and password have been verified. In another embodiment, files downloaded from the server 204 are received by the plug-in module 220 and stored in the cache of the client computing device 202 partitioned to support the local web browser. In effect, this reduces the network bandwidth necessary to download or update the plug-in.

The server 204 comprises a download module 206 and an update module 208. Each module includes executable source code that can be downloaded to the client computing device 202. To download the plug-in, module 206 transmits the files associated with the plug-in to the client computing device 202 via the network 210 using a transfer protocol. In one embodiment, these files comprise source code for the parser module 214, a list of buttons that can be presented as options, the options that can be performed, icons of the buttons, and preview code for displaying the smart menus. As will be discussed in further detail with reference to FIG. 3, the files may be signed with a hash value to ensure the client computing device 202 receives secure files. Embodiments are not limited thereto, however. Rather, one skilled in the art will appreciate that various data associated with the plug-in may be initially or periodically downloaded as well.

The update module 208 is configured to transmit updates of the files associated with the plug-in to the client computing device 202. The updates may be set to transmit periodically (e.g., hourly, weekly, monthly, etc.) or whenever an update needs to be made. Specifically, the update module 208 enables the probabilistic module 218 to constantly be updated according to various heuristics and probability models. In other words, the probabilistic module 218 can be updated to learn how to identify types of web content. For example, if a street address changes, and the change is detected by the server 204, the update module 208 may modify the probabilistic module 218 to identify the change in the future. Similarly, changes to images, smart menu sizes, presentation components, and other plug-in values may also be modified using the update module 208.

Turning now to FIG. 3, a flowchart is presented illustrating a process for transferring data associated with a web-browser plug-in to a client computing device, according to an embodiment of the present invention. FIG. 3 is meant purely for illustrative purposes and should not be construed to limit embodiments described herein.

Initially, a pointer file is received by the client computing device 202, illustrated at 302. The user may download the pointer file from a specific web page. The pointer file provides a reference to an IP address where files for the plug-in are located. When updates to the plug-in files are published, the pointer file may be modified to point to proxy servers or other computing devices that may contain the updates. The pointer file may first have to be checked to verify whether it actually came from the vendor who is purporting to send it, as illustrated at 304.

The server 204 and the client computing device 202 may use various well-known cryptographic methods for verifying the content. For instance, a hash value may be assigned to the header file. Public and private keys may be required for the client computing device 202 to download the data. In one embodiment, the hash values are stored in trusted, signed files so as to ensure they are safe and originally from the vendor.

If the vendor cannot be verified, the pointer file may be discarded (illustrated at 306), and a new pointer file will be at 302. If the vendor is verified, a hash-list file is retrieved from the vendor (e.g., on the server 204), as illustrated at 308. The hash-list file contains a list of hash values that can be used to verify the authenticity of transferred files for the plug-in. In an embodiment, the hash-list file is signed by the vendor, and that signature must be verified by the client computing device 202, illustrated at 310. If the hash-list file is not verified, it is discarded, illustrated at 312. This may require a new pointer file to be retrieved. But if the hash-list file can be verified to be signed by the vendor (e.g., with a private key), the client computing device 202 may then download files for the web-browser plug-in, illustrated at 314.

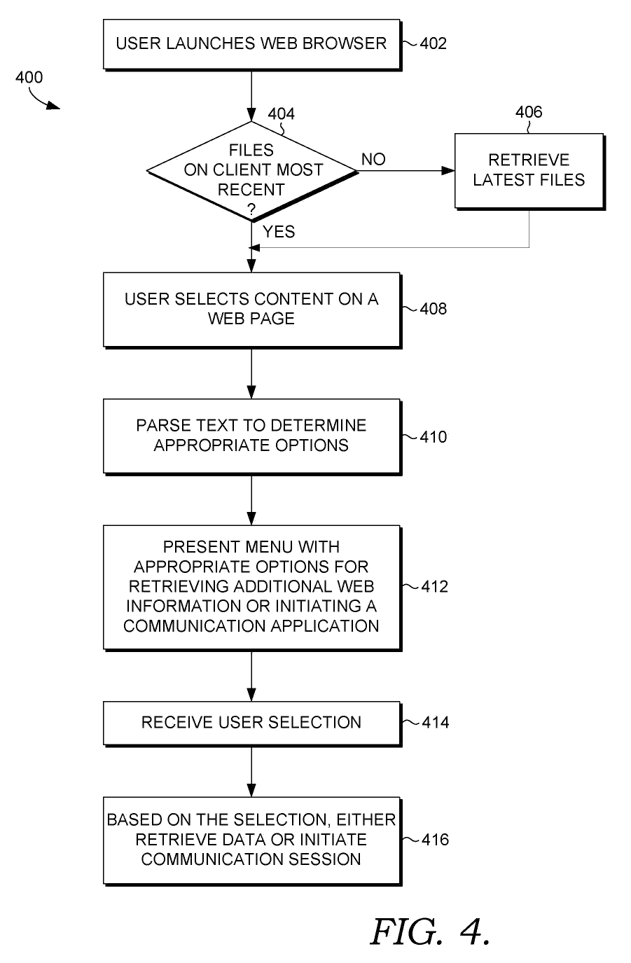

Turning now to FIG. 4, a flowchart is presented illustrating a process 400 for transferring data associated with a web-browser plug-in to a client computing device, according to an embodiment of the present invention. Initially, a user launches a web browser on a client computing device (e.g., the client computing device 202), illustrated in block 402. Once launched, the client computing device is checked to determine whether the most recent plug-in files have been received, illustrated at block 404. In one embodiment, the cache associated with the web browser is checked. In an alternative embodiment, a server (e.g., the server 204) is polled to determine whether new files have been released. If the files on the client computing device are not the most recent, the new files are downloaded from the server, illustrated at block 406.

Once new files have been downloaded or if the client computing device already had the most recent files, the user selects content on a web page, illustrated at block 408. Such a selection may be made by double-clicking a mouse cursor on the content, dragging the cursor across the content, highlighting the web content, or any other well-known method of selecting web content.

The selected content is parsed to determine the appropriate options to place on the smart menu, illustrated at block 410. In one embodiment, the parser module 214 determines the type of content selected by the user, using the expression module 216 and the probabilistic module 218. Then, the smart menu may be created to ascertain the options available to the user for the user-specified web content. Depending on the web content, the user may select to retrieve additional web information or initiate a communication application.

Options of the smart menu are selected based on user-selected web content. For example, if an e-mail address is selected, e-mailing the person may be an option provided on the smart menu. If a street address is selected, retrieving a map of the address along with options to get driving directions to/from the address may be appropriate options provided on the smart menu. Options not related to the user-selected web conten are not included on the smart menu. In other words, when a user selects an e-mail address, an option to retrieve a stock price will not be selected or displayed on the smart menu.

In an embodiment, the resultant options are then presented to the user to either retrieve additional web information or initiate a communication application, illustrated at block 412. In an embodiment, the user can then select an option, illustrated at 414. As a result, either additional web information is retrieved or a communication application is initiated, illustrated at 416. In an alternative embodiment, the user is not presented with a choice of options. Instead, either additional web information about the web content is automatically retrieved (e.g., on a background thread), or a communication application is automatically initiated with the web content. For example, when a street address is selected, the map may be retrieved and displayed without any further user interaction. Alternatively, if a telephone number is selected, a GUI illustrating a phone may be presented with a selected phone number ready to dial.

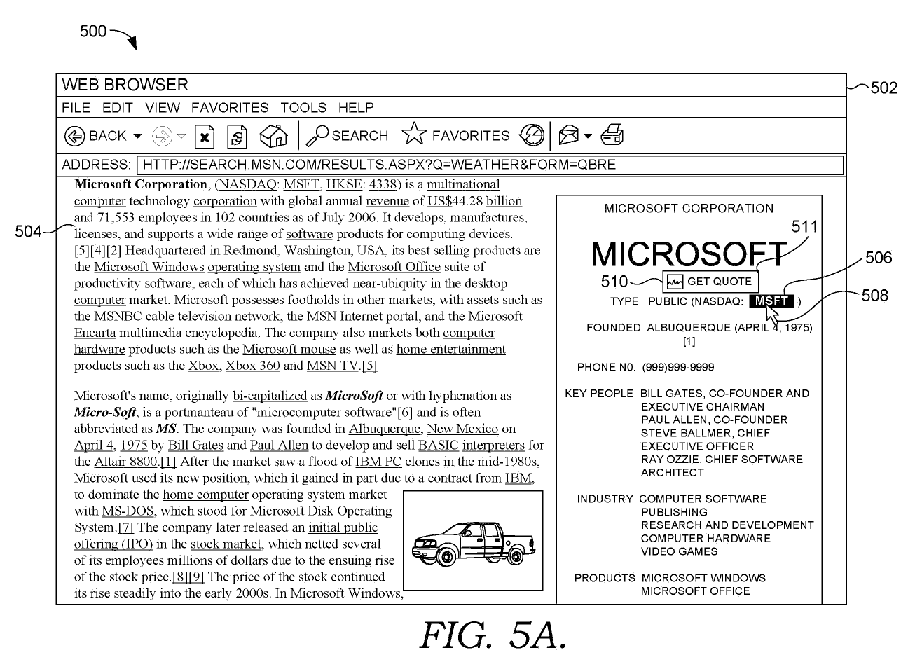

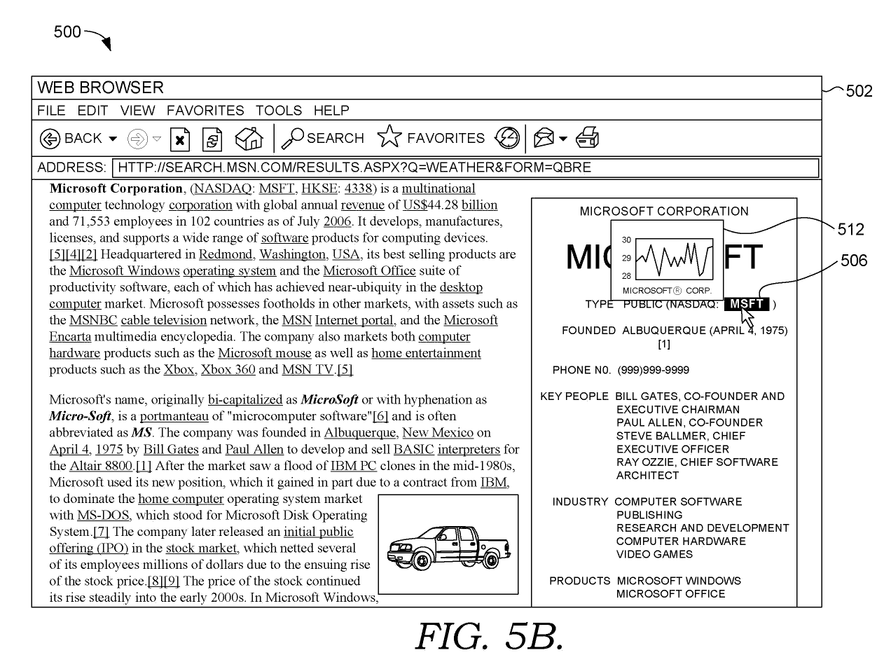

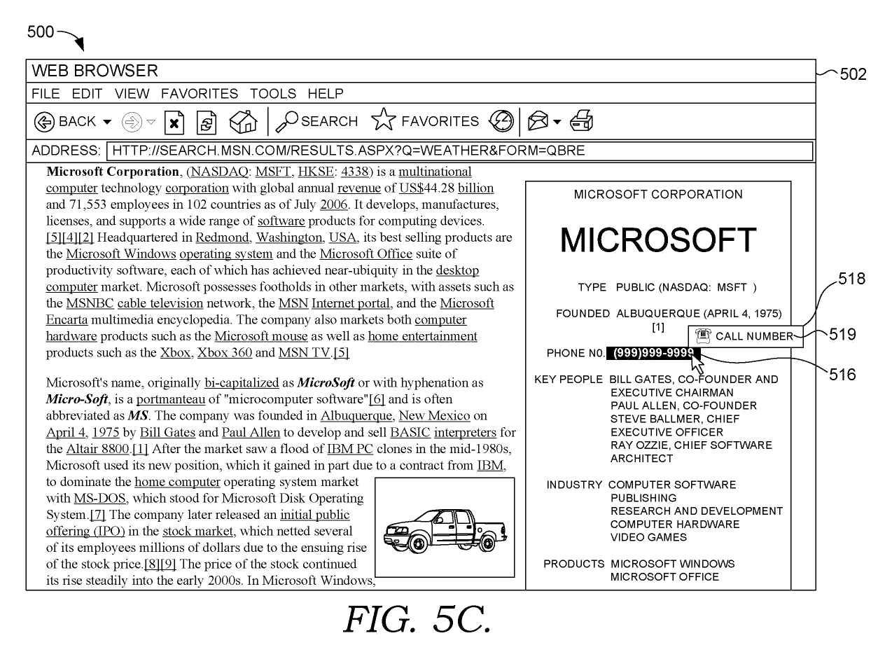

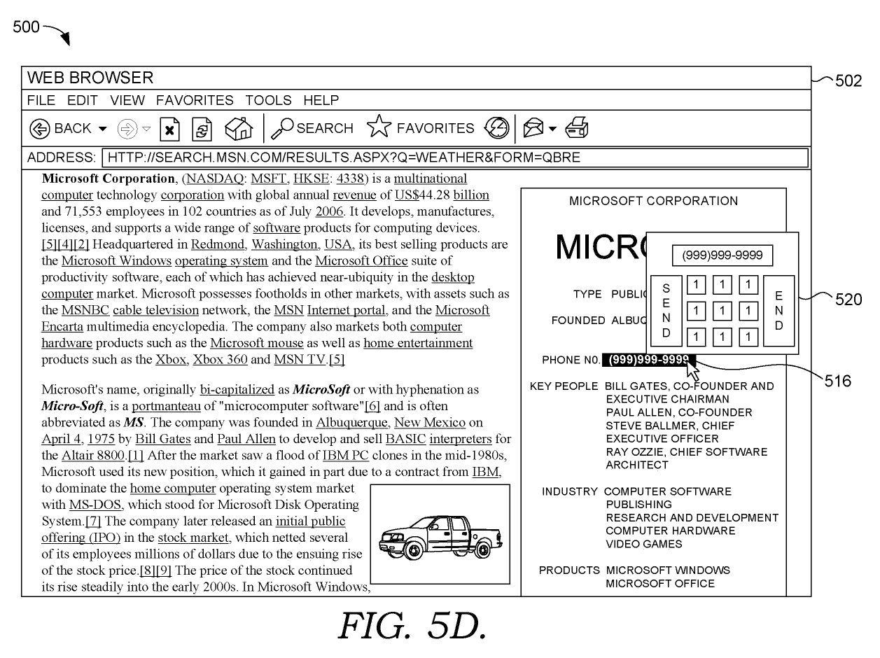

Turning now to FIGS. 5A and 5B, an exemplary GUI 500 is shown illustrating the presentation of additional web information about user-selected web content, according to an embodiment of the present invention. A web browser window 502 is depicted presenting a web page 504. A user has selected a stock symbol with a mouse cursor 508. More specifically, the stock symbol MSFT has been highlighted to indicate the user's selection. The highlighted symbol represents web content 508.

Once web content 508 is selected, a smart menu 510 is presented with an option 511 to “GET QUOTE,” which represents additional web information. Before the option 511 is displayed, a plug-in of the web browser 502, in one embodiment, determines the type of web content selected by the user. While FIG. 5A illustrates a smart menu 510 with a single option 511, embodiments are not limited thereto. Rather, multiple options may be displayed in the smart menu 510. In an alternative embodiment, an option to retrieve profits for a particular year is also presented within the smart menu 510.

FIG. 5B illustrates the situation where the user selects the option to retrieve the additional web content. If the option 511 is selected, the stock quote (i.e., the additional web information) is retrieved from a web service or a web page. For example, the current stock quote for Microsoft® may be obtained from www.nyse.com. In an embodiment, the retrieved information is presented as an overlay of the web browser window 502. Other methods of presentation are also possible and will be understood by those skilled in the art.

Depending on the type of web content selected, a communication application may be an appropriate option. FIG. 5C illustrates an exemplary display of GUI 500 presenting an option to initiate a communication application, according to an embodiment of the present invention. In FIG. 5C, the user of the web browser window 502 has selected web content 516, which is a phone number on a web page. As a result, a smart menu 518 is displayed with an option 519 to call the phone number. If the user selects the option 519, a phone application will initiate. FIG. 5 shows an initiated phone application 520 as an overlay of the web browser window 502. This enables the user to dial selected phone number.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon for presenting one or more options related to web content selected by a user, wherein the web content is part of a web page, comprising:
receiving a first selection from the user that designates content on the web page;
based on the content selected by the user, determining whether the user can retrieve additional web information about the content or initiate a communication application with the content;
presenting a menu of one or more options to retrieve the additional web information about the content or initiate the communication application with the content;
receiving a second selection from the user that designates whether to retrieve the additional web information about the content or initiate the communication application with the content; and
based on the second selection, either retrieving the additional web information about the content via the Internet or initiating the communication application with the content.

2. The one or more computer-readable media of claim 1, wherein the additional web information comprises web content calculated by a web service executing on a server.

3. The one or more computer-readable media of claim 1, wherein the communication application uses a voice over Internet protocol (VOIP) to connect a client computing device to a telephone.

4. The one or more computer-readable media of claim 1, wherein the menu of one or more options comprises one or more icons.

5. The one or more computer-readable media of claim 1, wherein the additional web information includes at least one of a map of a street address, a weather report for a geographic location, or a price associated with a stock.

6. The one or more computer-readable media of claim 1, wherein the options comprise retrieving one of at least one a map of a street address, a weather report for a geographic location, or a price associated with a stock.

7. The one or more computer-readable media of claim 1, wherein retrieving the additional web information about the content comprises receiving the information relevant to the content from a second web page.

8. The one or more computer-readable media of claim 1, wherein the additional web information comprises data requested from a web service executing on a server.

9. The one or more computer-readable media of claim 1, wherein the communication application comprises at least one of an e-mail messenger or an instant messenger service.

10. The one or more computer-readable media of claim 1, wherein the communication application uses a voice over Internet protocol (VOIP) to connect a first client computing device to at least one of a second computing device or a telephone.

11. A graphical user interface embodied on a computer-readable medium and executable on a computer, the graphical user interface comprising:
a first display area configured for displaying web content that has been selected by a user, wherein the web content is part of a web page;
a second display area configured for displaying a menu that contains one or more options for retrieving additional web information related to the web content; and
incident to receiving the additional web information, a third display area configured for displaying the additional web information.

12. The graphical user interface of claim 11, wherein the menu contains one or more options for initiating a communication application.

13. The graphical user interface of claim 12, further comprising a fifth display area configured for displaying, incident to the user's request, a user interface associated with the communication application.

14. The graphical user interface of claim 12, wherein the communication application is at least one of an e-mail service or an instant messenger service.

15. The one or more computer-readable media of claim 12, wherein the communication application uses a voice over Internet protocol (VOIP) service to connect a first client computing device to at least one of a second computing device or a telephone.

16. The graphical user interface of claim 11, wherein the additional web information includes at least one of a map of a street address, a weather report for a geographic location, or a price associated with a stock.

17. The graphical user interface of claim 11, wherein the options comprise retrieving one of at least one a map of a street address, a weather report for a geographic location, or a price associated with a stock.

18. One or more computer-readable media having computer-executable modules configured to present one or more options related to web content selected by a user, wherein the web content is part of a web page, comprising:
a web browser;
a parser module coupled with the web browser, wherein the parser module is configured to determine what type of web content was selected by the user; and
a presentation module communicating with the parser module,
wherein the presentation module determines one or more options to present to the user based on the type of information the web content displays, and
wherein the one of more options include at least one of a request for additional web information about the web content or a request to initiate a communication application with the web content.

19. The one or more computer-readable media of claim 18, wherein the parser module comprises:
an expression module configured to determine whether the web content is an electronic mail (e-mail) address or a telephone number; and
a probabilistic module configured to apply a heuristic model to determine the type of information the web content displays.

20. The one or more computer-readable media of claim 18, wherein the options comprise retrieving one of at least one a map of a street address, a weather report for a geographic location, or a price associated with a stock.
